(19) United States
(12) Patent Application Publication
(10) Pub. No.: US 2026/0274577 A1
(43) Pub. Date: Sep. 17, 2026

(54) FLOW RAIL SYSTEM AND PALLET STOP APPARATUS

(71) Applicant: Woodsage LLC, Holland, OH (US)

(72) Inventors: Patrick Cucco, Ashland, OH (US); Adam Robert Webster, Toledo, OH (US); Zachary Dale Ernest, Galion, OH (US); Rodger Brian Davis, Mansfield, OH (US); Collin Sullivan, Parkville, MO (US)

(73) Assignee: Woodsage LLC, Holland, OH (US)

(21) Appl. No.: 19/566,321

(22) Filed: Mar. 13, 2026

Related U.S. Application Data
(60) Provisional application No. 63/771,349, filed on Mar. 13, 2025.

(51) Int. Cl. B65G 13/07; B65G 13/11

(52) U.S. Cl. CPC B65G 13/07; B65G 13/11

(57) ABSTRACT

A roller for a conveyor system is provided. The roller may include a body, an axle, a first end connector, and a spring. The body may include a first end and a second end opposite the first end. The axle may be disposed in the body extending from the first end to the second end. The first end connector may be configured to interface with the body on the first end. The first end connector may protrude at least partially past the first end. The spring may be configured to interface with the body and the first end connector. The spring may be configured to provide a restoring force to the first end connector when depressed.

### CROSS-REFERENCE TO RELATED APPLICATIONS

This application claims priority to U.S. Provisional Application No. 63/771,349, filed on March 13, 2025, which is incorporated by reference in its entirety.

### FIELD OF DISCLOSURE

This application generally relates to a flexible conveyor system and a roller apparatus.

### BACKGROUND

Conveyor systems utilize rollers and drive belts powered by motors to move large quantities of items throughout a warehouse. The rollers are generally bolted to the frame of the conveyor system and are coupled to the motor with a high-tension drive belt. With use, the drive belt may wear down and break requiring maintenance. When the drive belt breaks, the conveyor system may not be operational. Conventional systems require specialized skill and tools to replace a drive belt, which can result in a large amount of system downtime.

### SUMMARY

In some embodiments, a roller for a conveyor system is provided. The roller may include a body, an axle, a first end connector, and a spring. The body may include a first end and a second end opposite the first end. The axle may be disposed in the body extending from the first end to the second end. The first end connector may be configured to interface with the body on the first end. The first end connector may protrude at least partially past the first end. The spring may be configured to interface with the body and the first end connector. The spring may be configured to provide a restoring force to the first end connector when depressed.

In some embodiments, a conveyor system is provided. The conveyor system may include a plurality of frame links, a bushing, and a roller. The plurality of frame links may include a first frame link and a second frame link. The first frame link may have a first top end. The second frame link may have a second top end. A first opening may be formed in the first frame link at the first top end. A second opening may be formed in the second frame link at the second top end. The bushing may be configured to interface with the first opening and the second opening. The bushing may couple the first frame link with the second frame link. The roller may include a body, an axle, a first end connector, and a spring. The body may include a first end and a second end opposite the first end. The axle may be disposed in the body extending from the first end to the second end. The first end connector may be configured to interface with the body on the first end. The first end connector may protrude at least partially past the first end. The first end connector may be configured to engage with the bushing. The spring may be configured to interface with the body and the first end connector. The spring may be configured to provide a restoring force to the first end connector when depressed.

### BRIEF DESCRIPTION OF THE FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1A depicts an illustrative conveyor system with spring-loaded rollers, in accordance with example embodiments.

FIG. 1B depicts a view of an illustrative conveyor system with spring-loaded rollers, in accordance with example embodiments.

FIG. 1C depicts a cross-section view of an illustrative conveyor system with a first end connector illustrated in a first position, in accordance with example embodiments.

FIG. 1D depicts a cross-section view of illustrative conveyor system with a first end connector illustrated in a second position, in accordance with example embodiments.

FIG. 2A depicts an illustrative conveyor system with pins, in accordance with example embodiments.

FIG. 2B depicts a detail of an illustrative conveyor system with pins, in accordance with example embodiments.

FIG. 3A depicts an illustrative conveyor system with a release mechanism in an operating position, in accordance with example embodiments.

FIG. 3B depicts a view of an illustrative conveyor system with a release mechanism in an operating position, in accordance with example embodiments.

FIG. 3C depicts an illustrative conveyor system with a release mechanism in a maintenance position, in accordance with example embodiments.

FIG. 3D depicts a view of an illustrative conveyor system with a release mechanism in a maintenance position, in accordance with example embodiments.

FIG. 4A depicts a roller including a groove, in accordance with example embodiments.

FIG. 4B depicts a groove on a roller interfacing with a drive belt, in accordance with example embodiments.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

One or more techniques described herein improve upon conventional systems by providing a system that enables an expedited process to change drive belts in conveyor systems. Current conveyor systems rely on qualified personnel to disassemble multiple bolted connections in order to remove drive belts, which may result in longer downtime for the system and increased cost in replacing worn out drive belts. The techniques described herein may include several embodiments which allow drive belts to be changed faster, with less labor, and with no specialized tools.

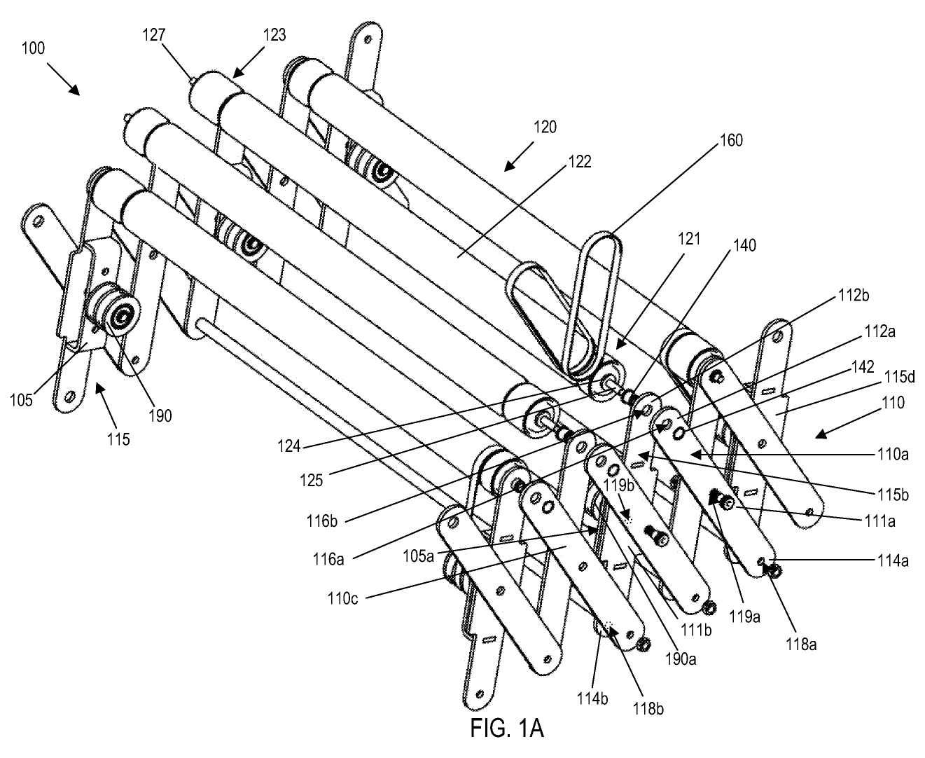

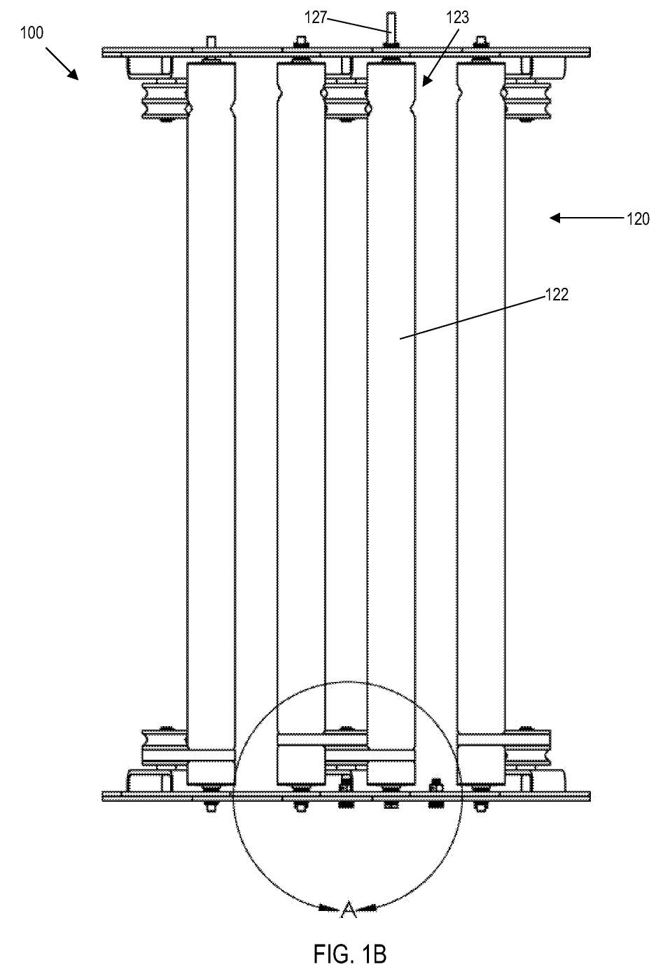

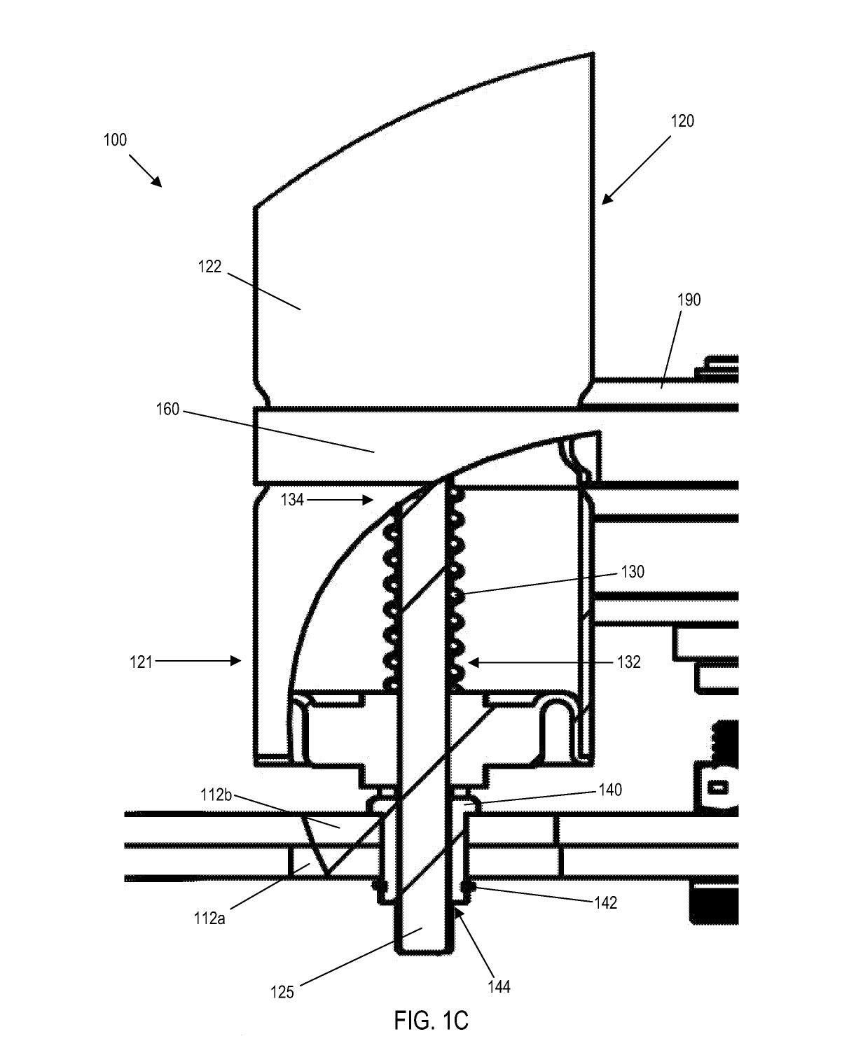

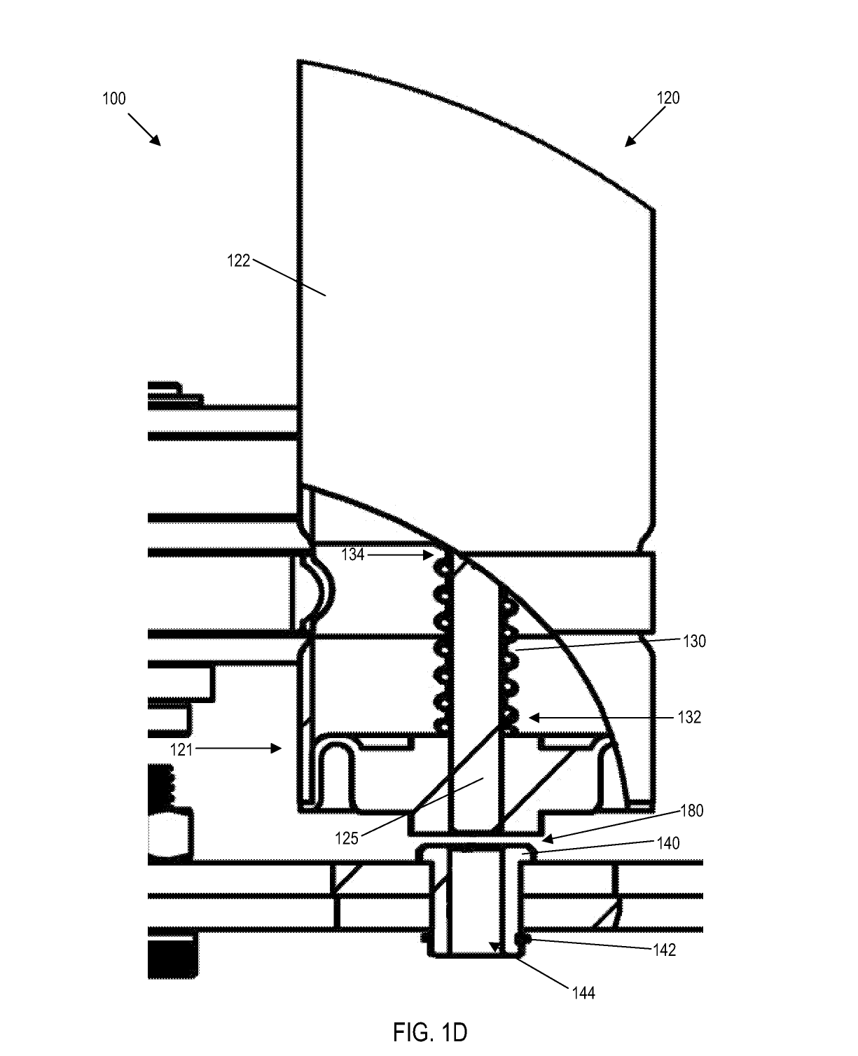

FIGS. 1A-1B depict a conveyor system 100 with spring-loaded passive rollers 120, in accordance with example embodiments. Conveyor system 100 may include a plurality of frame links 110. The plurality of frame links 110 may include at least a first frame link 110a and a second frame link 115b.

First frame link 110a may include a body 111a having a top end 112a and a bottom end 114a. Body 111a may include one or more openings formed therein. For example, body 111a may include three openings formed therein: a first opening 116a formed proximate the top end 112a, a second opening 118a formed proximate the bottom end 114a, and a third opening 119a formed in the body 111a between first opening 116a and second opening 118a.

Second frame link 115b may be configured similar to first frame link 110a. In particular, second frame link 115b may include a body 111b having a top end 112b and a bottom end 114b. Body 111b may include a middle portion 105a between top end 112b and bottom end 114b, substantially similar to middle portion 105. In some embodiments, body 111b may be wider proximate middle portion 105a than proximate top end 112b and bottom end 114b. Body 111b may include one or more openings formed therein. For example, body 111b may include three openings formed therein: a first opening 116b formed proximate the top end 112b, a second opening 118b formed proximate the bottom end 114b, and a third opening 119b formed in the body 111b between first opening 116b and second opening 118b.

First frame link 110a may be coupled with second frame link 115b at their respective top ends 112a, 112b, thereby forming a scissor pattern. For example, as shown, top end 112a of first frame link 110a may be coupled with top end 112b of second frame link 115b via a bushing 140 extending through first opening 116a and first opening 116b. Bushing 140 may include an axial opening 144 and a bushing collar 142. Bushing collar 142 may be configured to interface with an end of bushing 140 such that bushing 140 couples top end 112a with top end 112b.

As shown, each bottom end 114a, 114b may be coupled to another frame link (e.g., frame link 110c and frame link 115d). In this manner, the plurality of frame links 110 are arranged in a repeating scissor pattern.

Conveyor system 100 may include a plurality of active rollers 190 and a plurality of passive rollers 120. Each of the plurality of active rollers 190 may be coupled with a respective frame link 115. For example, as shown, an active roller 190a may be coupled with frame link 115b. In some embodiments, active roller 190 may be coupled to middle portion 105 of frame link 115. Each active roller 190 may be communicatively coupled with a motor or drive unit (not shown). Plurality of active rollers 190 may be configured to drive the drive belts 160 of the conveyor, which in turn causes plurality of passive rollers 120 to rotate. In some embodiments, plurality of active rollers 190 may be positioned on a different plane than plurality of passive rollers 120. In some embodiments, there may be fewer active rollers 190 than passive rollers 120. For example, as shown, active rollers 190 may be disposed throughout the conveyor system 100, such that active rollers 190 are coupled to every other frame link 115.

Each passive roller 120 may include a body 122 having a first end 121, a second end 123, and an axle 124 extending from first end 121 to second end 123. First end 121 may include a first end connector 125. First end connector 125 may be configured to interface with axle 124 on first end 121. First end connector 125 may protrude at least partially past first end 121 of body 122. First end connector 125 may be coaxial with body 122. Body 122 may include a spring 130 disposed in first end 121. Spring 130 may be engaged with first end connector 125 at a first end 132 and engaged with body 122 at a second end 134. Spring 130 may be configured to provide a restoring force to first end connector 125 when depressed. Second end 123 may include a second end connector 127. In some embodiments, second end connector 127 may be substantially similar to first end connector 125. In some embodiments, second end connector 127 may be fixed such that it cannot be depressed. In some embodiments, first end connector 125 and second end connector 127 may be end portions of axle 124, and axle 124 may be retained within body 122 with first end connector 125 and second end connector 127 configured to extend beyond first end 121 and second end 123 of body 122, respectively, as shown in FIG. 1A. In some embodiments, when first end connector 125 is depressed, second end connector 127 may extend further from second end 123 of body 122.

Conveyor system 100 may include a drive belt 160 configured to engage with each active roller 190 and passive roller 120. In operation, the motor or drive unit may drive or power plurality of active rollers 190 such that plurality of active rollers 190 drive drive belts 160 which in turn rotate plurality of passive rollers 120.

FIG. 1C depicts a cross-section view of conveyor system 100 with first end connector 125 illustrated in a first position, in accordance with example embodiments. As shown, in the first position, first end connector 125 may extend through axial opening 144, beyond a body of bushing 140. In this first position, first end connector 125 secures a passive roller 120 to conveyor system 100. For example, in the first position, end connector 125 passes through first opening 116a of first frame link 110a and first opening 116b of second frame link 115b via bushing 140. In the first position, spring 130 of passive roller 120 may be in a relaxed position.

FIG. 1D depicts a cross-section view of conveyor system 100 with first end connector 125 illustrated in a second position, in accordance with example embodiments. As discussed above, spring 130 may be coaxial with first end connector 125. In order to remove roller 120 from conveyor system 100, first end connector 125 may be depressed against a first end 132 of spring 130 by pushing first end connector 125 through axial opening 144 of bushing 140. This action may be performed using any tool with a diameter able to enter axial opening 144. For example, this action may be performed using a hex key or a pen. When first end connector 125 is depressed, a gap 180 between roller 120 and bushing 140 may allow roller 120 to be removed from conveyor system 100. Thus, this design allows for the removal of passive roller 120 quickly and without specialized tools. Spring 130 being compressed against body 122 interfacing with second end 134 may cause a restoring force such that when first end connector 125 is released, first end connector 125 may be restored from its second position to its extended, first position.

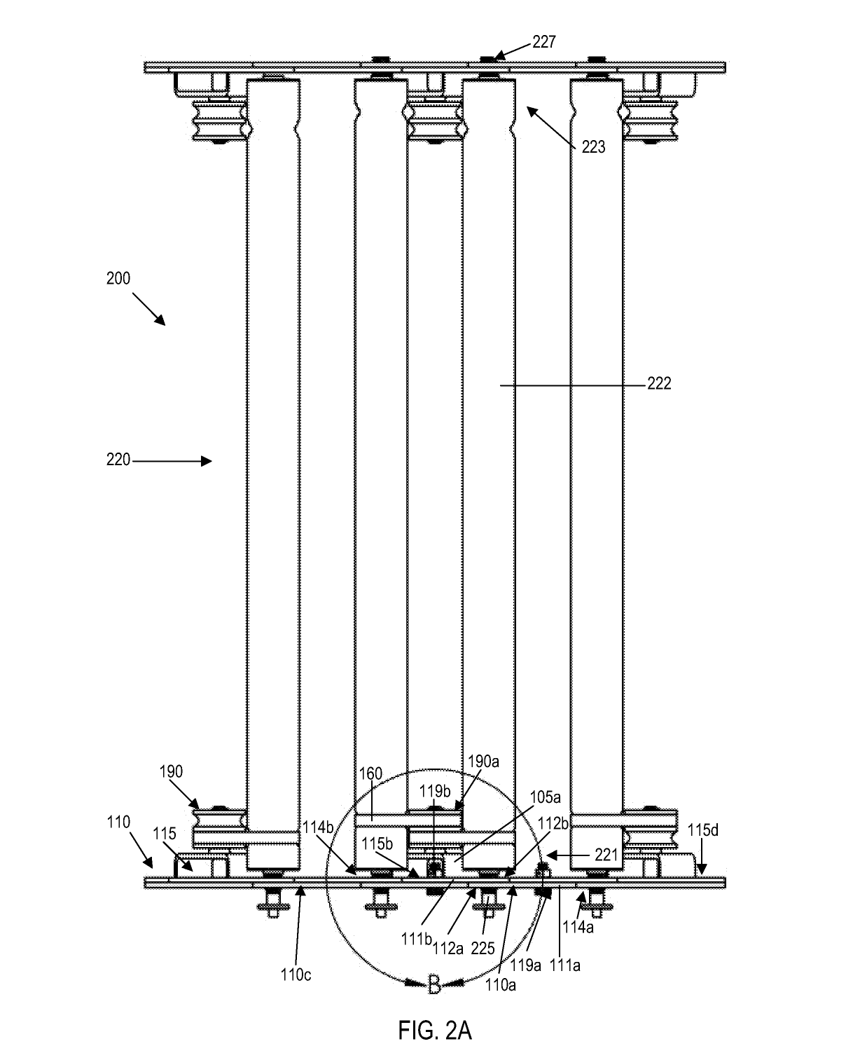

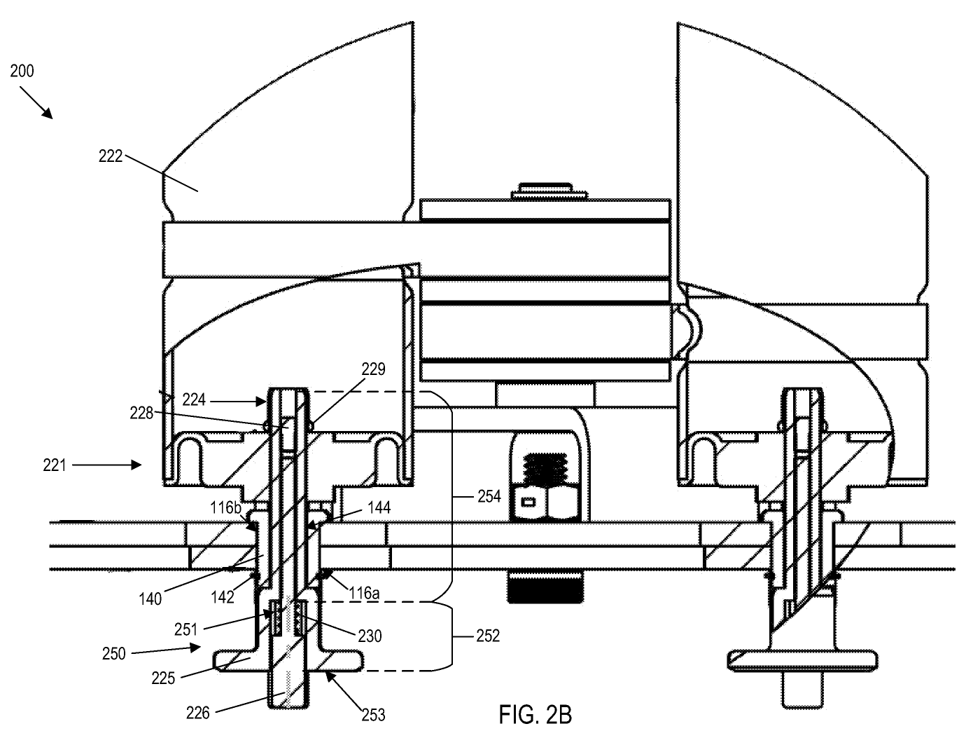

FIGS. 2A-2B depict a conveyor system 200 with pins 250, in accordance with example embodiments. Conveyor system 200 may be substantially similar to conveyor system 100. However, conveyor system 200 utilizes a different type of passive roller compared to conveyor system 100. For ease of discussion, like reference numerals are used where appropriate.

Each passive roller 220 may include a body 222 having a first end 221 and a second end 223. At least first end 221 may define an axial opening 224 therein. In some embodiments, second end 223 may define an axial opening substantially similar to axial opening 224. In some embodiments, second end 223 may include a second end connector 227 configured to engage with the plurality of frame links 110. Conveyor system 200 may include a plurality of pins 250 configured to extend through bushing 140 and interface with axial opening 224 such that pin 250 may support body 222 of passive roller 220.

Pin 250 may include a pin body 225, a plunger 226, a spring 230, and a locking portion 228. Plunger 226, spring 230, and locking portion 228 may be coaxial with pin body 225. Pin body 225 may include an axial opening 251 extending through pin body 225. Axial opening 251 may include a first portion 252 and a second portion 254. First portion 252 may have a radius larger than a radius of second portion 254. First portion 252 may be configured to at least partially surround spring 230. Plunger 226 may be housed within axial opening 251 such that plunger 226 may extend through at least a portion of first portion 252 and at least a portion of second portion 254. Plunger 226 may extend beyond an outer face 253 of pin body 225.

Locking portion 228 may include one or more tabs 229 configured to engage with axial opening 224 of body 222 such that pin 250 may be locked into place. Plunger 226 may displace locking portion 228 when plunger 226 is depressed such that tabs 229 may be withdrawn allowing pin 250 to be removed from axial opening 224. When pin 250 is removed from axial opening 224, passive roller 220 may be removed from conveyor system 200. In some embodiments, second end 223 may define an axial opening defined therein substantially similar to axial opening 224 and configured to interface with a pin 250.

Spring 230 may be configured to interface with plunger 226 and pin body 225 such that spring 230 may provide a restoring force to plunger 226 when depressed. When plunger 226 is released, the expansion of spring 230 may restore plunger 226 to its original position such that locking portion 228 may return to its original locking position engaging with axial opening 224.

Conveyor system 200 may include a drive belt 160 configured to engage with each active roller 190 and passive roller 220. In operation, the motor or drive unit may drive or power plurality of active rollers 190 such that plurality of active rollers 190 drive drive belts 160 which in turn rotate plurality of passive rollers 220.plurality of frame links 110.

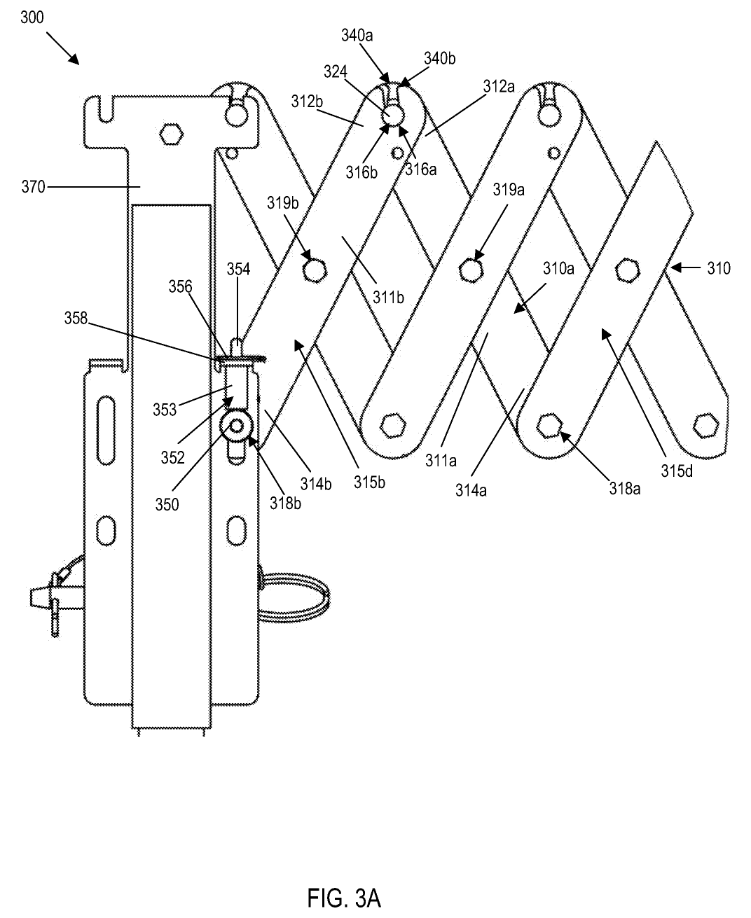

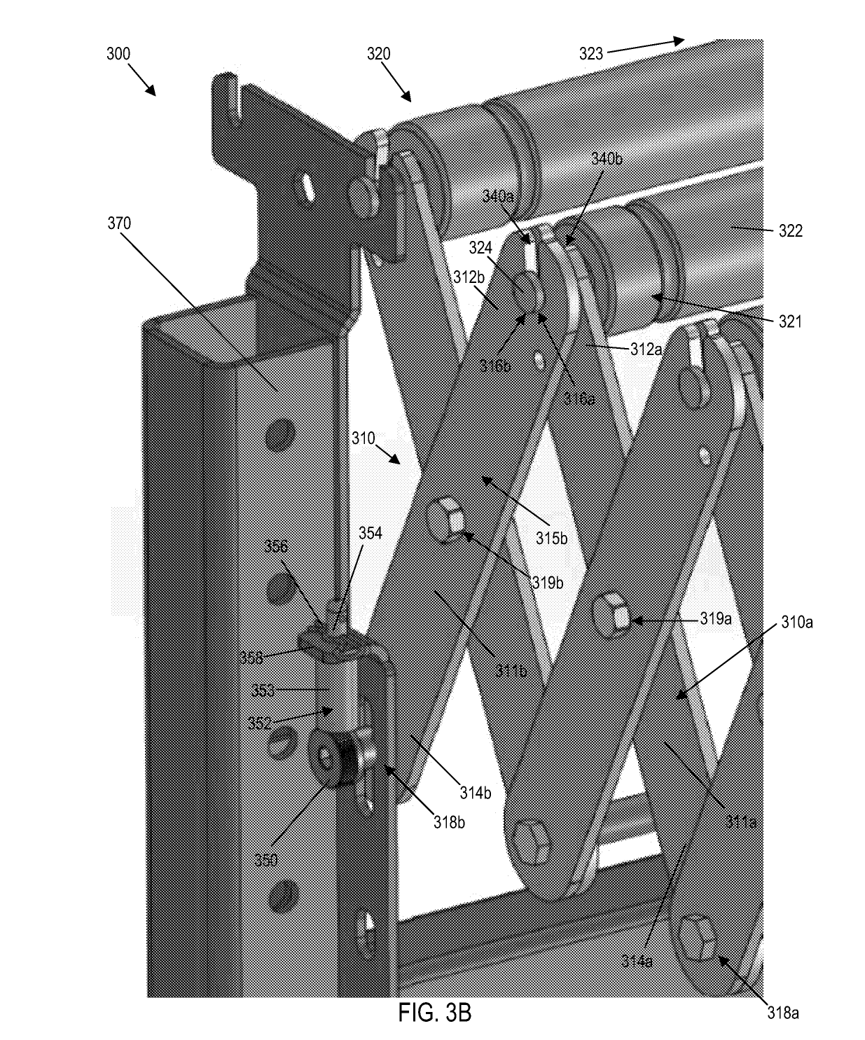

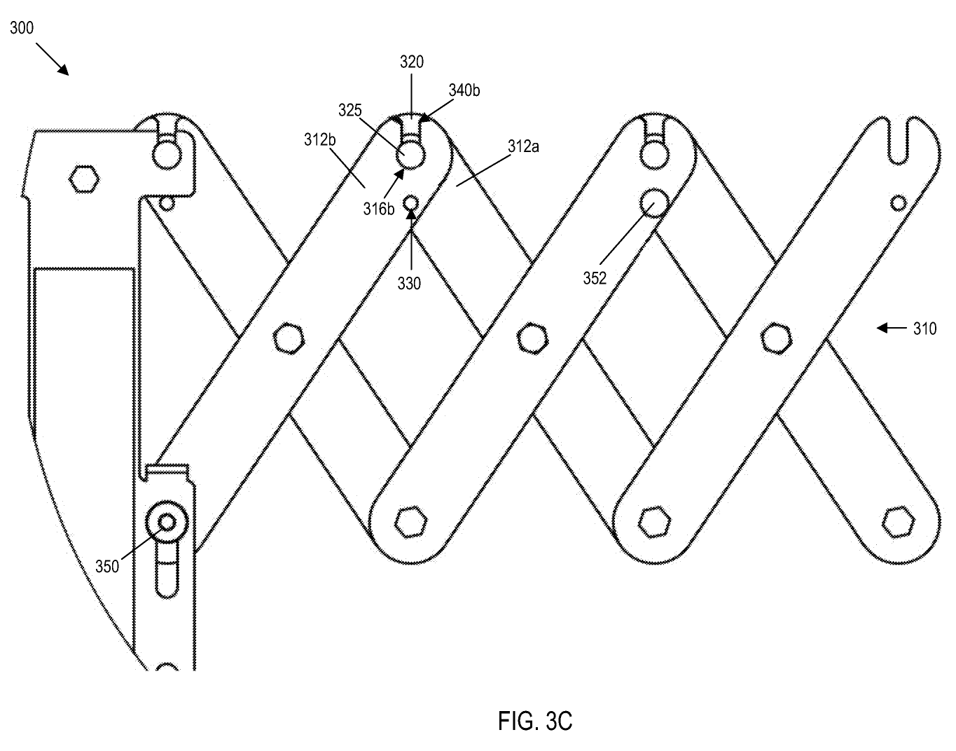

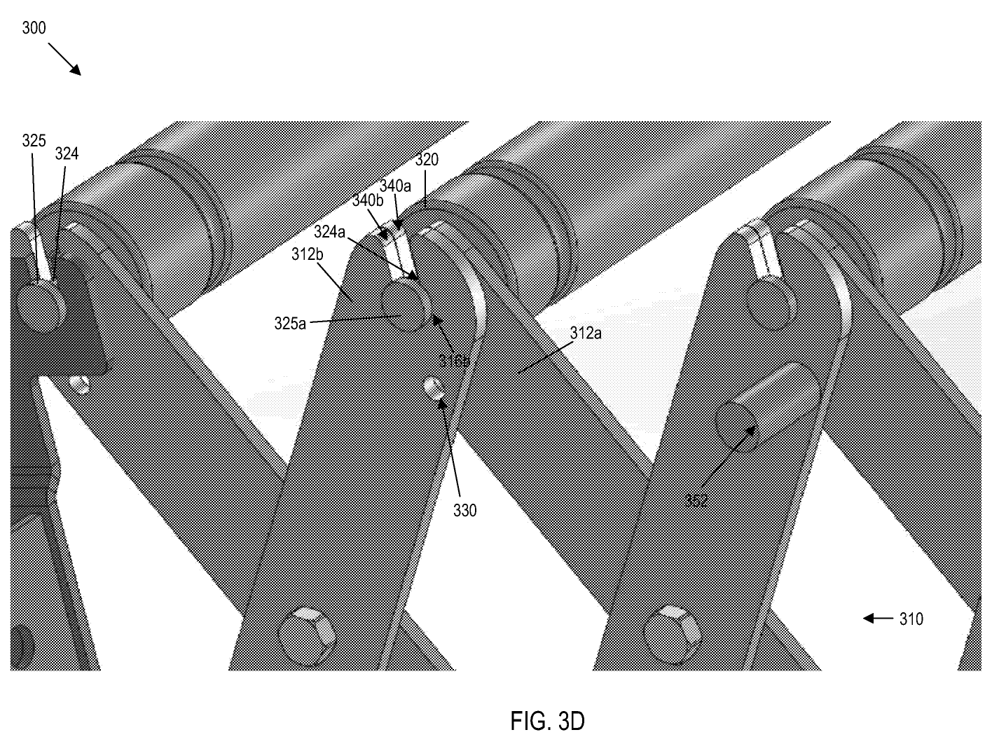

FIGS. 3A-3D depict an illustrative conveyor system 300 with a release mechanism, in accordance with example embodiments. The system 300 may include a plurality of frame links 310. The plurality of frame links 310 may include at least a first frame link 310a and a second frame link 315b.

First frame link 310a may include a body 311a having a top end 312a and a bottom end 314a. Body 311a may include one or more openings formed therein. For example, body 311a may include three openings formed therein: a first opening 316a formed proximate the top end 312a, a second opening 318a formed proximate the bottom end 314a, and a third opening 319a formed in the body 311a between first opening 316a and second opening 318a. Top end 312a may define a first notch 340a. First notch 340a may be in communication with first opening 316a.

Second frame link 315b may be configured similar to first frame link 310a. In particular, second frame link 315b may include a body 311b having a top end 312b and a bottom end 314b. In some embodiments, body 311b may include a middle portion, substantially similar to middle portion 105. In some embodiments, body 311b may be wider proximate the middle portion than proximate top end 312b and bottom end 314b. Body 311b may include one or more openings formed therein. For example, body 311b may include three openings formed therein: a first opening 316b formed proximate the top end 312b, a second opening 318b formed proximate the bottom end 314b, and a third opening 319b formed in the body 311b between first opening 316b and second opening 318b. Top end 312b may define a second notch 340b. Second notch 340b may be in communication with first opening 316b.

As shown, bottom end 314a may be coupled to another frame link (e.g., frame link 315d). In this manner, the plurality of frame links 310 are arranged in a repeating scissor pattern. Bottom end 314b may be slidably engaged with a frame 370 of conveyor system 300 via bolt 350 engaged with second opening 318b.

Conveyor system 300 may include a plurality of passive rollers 320. In some embodiments, conveyor system 300 may include a plurality of active rollers substantially similar to active rollers 190.

Each passive roller 320 may include a body 322 having a first end 321, a second end 323, and an axle 324 extending from first end 321 to second end 323. Axle 324a may be configured to interface with first opening 316a and first opening 316b. In some embodiments, axle 324 may include an axle cap 325 with a radius greater than a radius of first opening 316a and first opening 316b such that axle 324 may be prevented from being withdrawn from first opening 316a and first opening 316b in an operating position. As shown in FIGS. 3A and 3B, in the operating position, first notch 340a and second notch 340b may be offset such that axle 324a may be secured within first opening 316a and first opening 316b. In some embodiments, axle cap 325a may further secure axle 324a within first opening 316a and first opening 316b by preventing axle 324a from being withdrawn. The operating position may provide for the operation of conveyor system 300 without passive roller 320 disconnecting from conveyor system 300. The plurality of frame links 310 may be secured in the operating position by a release mechanism including a pin 352 impeding a vertical motion of bolt 350 coupled to bottom end 314b such that the plurality of frame links 310 cannot be extended. Pin 352 may include a top portion 354 with a radius smaller than a body 353 of pin 352. Top portion 354 may be configured to extend through a portion 358 of frame 370 of conveyor system 300. Top portion 354 may be secured by a cotter pin 356, or the like, such that pin 352 may be secured relative to frame 370.

When passive roller 320 needs to be disconnected from conveyor system 300, for example, for maintenance of conveyor system 300, conveyor system 300 may be extended into a maintenance position. Cotter pin 356 may be removed from top portion 354 releasing pin 352 from frame 370. With pin 352 removed, conveyor system 300 may be extended. The extension of conveyor system 300 may cause the scissor pattern of the plurality of frame links 310 to open causing top end 312a and top end 312b to rotate relative to each other. As shown in FIGS. 3C and 3D, in the maintenance position, first notch 340a may align with second notch 340b as a result of the rotation of top end 312a and top end 312b. The alignment of first notch 340a with second notch 340b may release axle 324a from first opening 316a and first opening 316b allowing for the removal of passive roller 320. In some embodiments, the maintenance position may provide a through hole 330 through top end 312a and top end 312b. In some embodiments, top portion 354 of pin 352 may be inserted into through hole 330 and secured by cotter pin 356 such that pin 352 may provide structural integrity to the plurality of frame links 310 in the maintenance position.

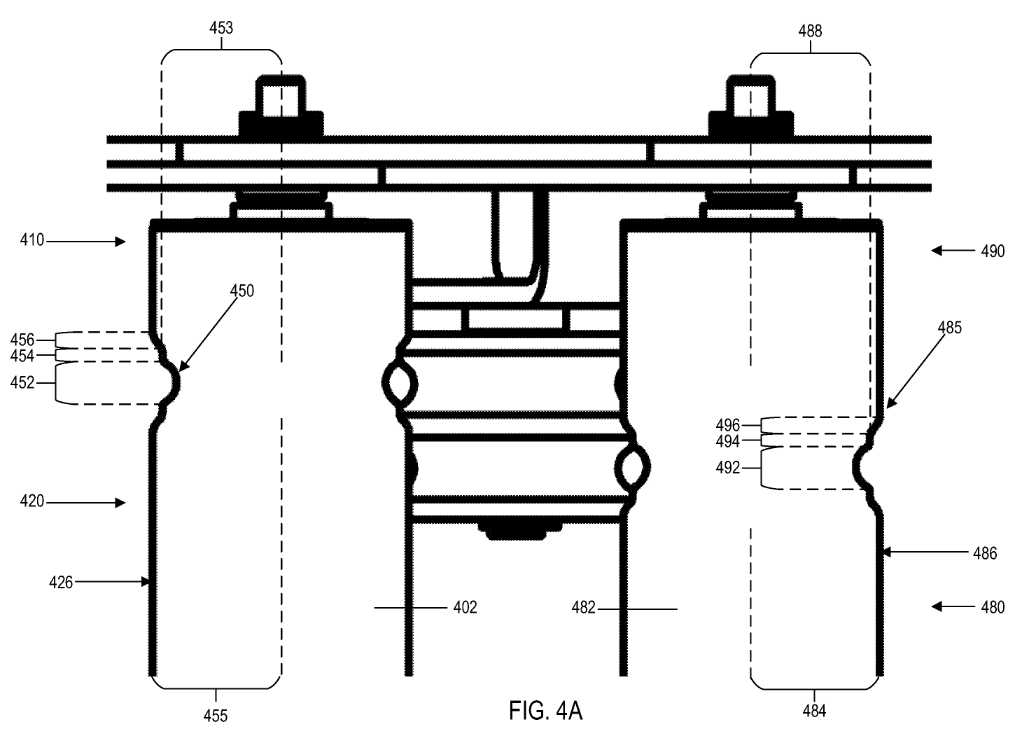

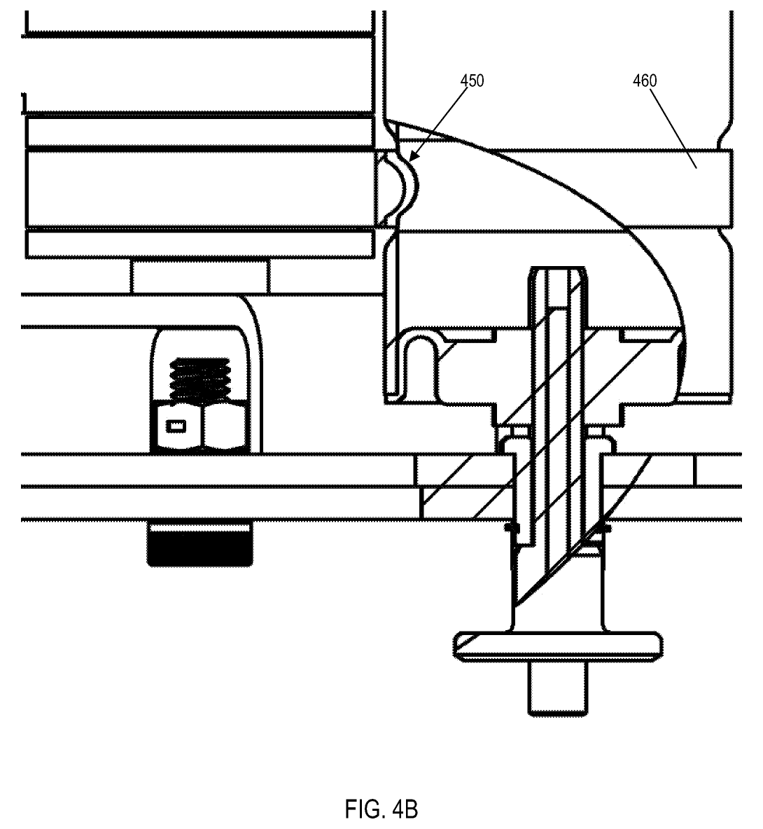

FIG. 4A depicts a passive roller 420, in accordance with example embodiments. Passive roller 420 may include a body 402. Body 402 may include a first end 410 and a second end (not shown). Body 402 may include a groove 450 formed in first end 410. Groove 450 may be configured to interface with a drive belt 460. Groove 450 may include a first portion 452, a second portion 454, and a third portion 456. First portion 452 may represent a parabolic shape. Second portion 454 may be substantially parallel to an outer surface 426 of passive roller 420 and may have a radius 453 less than a radius 455 of passive roller 420. Second portion 454 may extend between first portion 452 and third portion 456. Third portion 456 may represent a ramped surface extending between second portion 454 and outer surface 426. Groove 450 may be symmetrical about a center of first portion 452 and may surround passive roller 420. Passive roller 420 may represent any of passive roller 120, passive roller 220, and passive roller 320.

Although second end of passive roller 420 is not shown, FIG. 4A illustrates a second passive roller 480 which is identical to passive roller 420. Second passive roller 480 includes a body 482. Body 482 includes a first end (not shown) and a second end 490. Body 482 includes a groove 485 formed in second end 490. Groove 485 may be configured to interface with another drive belt. Groove 485 may include a first portion 492, a second portion 494, and a third portion 496. First portion 492 may represent a parabolic shape. Second portion 494 may be substantially parallel to an outer surface 486 of passive roller 480 and may have a radius 488 less than a radius 484 of passive roller 480. Second portion 494 may extend between first portion 492 and third portion 496. Third portion 496 may represent a ramped surface extending between second portion 494 and outer surface 486. Groove 485 may be symmetrical about a center of first portion 492 and may surround second passive roller 480.

FIG. 4B depicts groove 450 interfacing with a drive belt 460, in accordance with example embodiments. The shape of groove 450 may provide more surface contact with drive belt 460 than existing systems. As drive belt 460 has more surface contact with groove 450, drive belt 460 may maintain higher tension with less stretching over its life cycle. Thus, the shape of groove 450 may enable longer lasting drive belts as compared to existing systems.

Additional examples of the presently described method and device embodiments are suggested according to the structures and techniques described herein. Other non-limiting examples may be configured to operate separately or may be combined in any permutation or combination with any one or more of the other examples provided above or throughout the present disclosure.

It will be appreciated by those skilled in the art that the present disclosure may be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language "means for" or "step for" be interpreted under 35 U.S.C. 112(f). Claims that do not expressly include the phrase "means for" or "step for" are not to be interpreted under 35 U.S.C. 112(f).

1. A roller for a conveyor system, the roller comprising:
a body, comprising:
a first end; and
a second end opposite the first end;
an axle disposed in the body extending from the first end to the second end;
a first end connector configured to interface with the body on the first end, the first end connector protruding at least partially past the first end; and
a spring configured to interface with the body and the first end connector, wherein the spring is configured to provide a restoring force to the first end connector when depressed.

2. The roller of claim 1, wherein the spring is coaxial with the first end connector and the body.

3. The roller of claim 1, further comprising:
a second end connector configured to interface with the body on the second end, the second end connector protruding at least partially past the second end.

4. The roller of claim 3, wherein the spring is a first spring, the roller further comprising:
a second spring configured to interface with the body and the second end connector, wherein the second spring is configured to provide a restoring force to the second end connector when depressed.

5. The roller of claim 4, wherein the first end connector and the second end connector are ends of the axle such that the first end connector and the second end connector are not configured to be in a depressed state simultaneously.

6. The roller of claim 4, wherein the first end connector and the second end connector are configured to be in a depressed state simultaneously.

7. The roller of claim 1, further comprising:
a groove surrounding at least one of the first end and the second end, the groove configured to interface with a drive belt.

8. The roller of claim 7, wherein the groove comprises a portion substantially parallel to an outer surface of the body.

9. The roller of claim 1, wherein the first end connector is a first end of the axle, and wherein the axle is slidably engaged with the body.

10. A conveyor system, comprising:
a plurality of frame links, the plurality of frame links comprising a first frame link and a second frame link, the first frame link having a first top end, the second frame link having a second top end, wherein a first opening is formed in the first frame link at the first top end and a second opening is formed in the second frame link at the second top end;
a bushing configured to interface with the first opening and the second opening, the bushing coupling the first frame link with the second frame link; and
a roller engaged with the bushing, the roller comprising:
a body, comprising:
a first end; and
a second end opposite the first end;
an axle disposed in the body extending from the first end to the second end;
a first end connector configured to interface with the axle on the first end, the first end connector protruding at least partially past the first end, the first end connector configured to engage with the bushing; and
a spring configured to interface with the axle and the first end connector, wherein the spring is configured to provide a restoring force to the first end connector when depressed.

11. The conveyor system of claim 10, wherein the spring is coaxial with the first end connector and the body.

12. The conveyor system of claim 11, wherein in a depressed state, the first end connector is disengaged from the bushing such that the roller may be removed from the conveyor system.

13. The conveyor system of claim 10, the roller further comprising:
a second end connector configured to interface with the body on the second end, the second end connector protruding at least partially past the second end.

14. The conveyor system of claim 13, wherein the spring is a first spring, the roller further comprising:
a second spring configured to interface with the body and the second end connector, wherein the second spring is configured to provide a restoring force to the second end connector when depressed.

15. The conveyor system of claim 14, wherein the first end connector and the second end connector are configured to be depressed simultaneously.

16. The conveyor system of claim 10, further comprising:
a groove surrounding at least one of the first end and the second end, the groove configured to interface with a drive belt.

17. The conveyor system of claim 16, wherein the groove comprises a portion substantially parallel to an outer surface of the body.

18. The conveyor system of claim 16, further comprising:
an active roller coupled to at least one of the first frame link and the second frame link; and
a drive belt configured to engage with the active roller and the groove.

19. The conveyor system of claim 10, wherein the first end connector is a first end of the axle, and wherein the axle is slidably engaged with the body.

20. The conveyor system of claim 10, further comprising:
a bushing collar configured to engage with an end of the bushing.
